(19) United States
(12) Patent Application Publication
(10) Pub. No.: US 2006/0276133 A1
(43) Pub. Date: Dec. 7, 2006

(54) Bluetooth activation and peer discovery

(75) Inventors: Van Ly, Vancouver (CA); Teemu Jalava, Espoo (FI); Jyri P. Salomaa, Jorvas (FI)

Correspondence Address: FOLEY & LARDNER LLP, 321 NORTH CLARK STREET, SUITE 2800, CHICAGO, IL, 60610-4764, US

(73) Assignee: Nokia Corporation

(21) Appl. No.: 11/173,828

(22) Filed: Jul. 1, 2005

Related U.S. Application Data
(60) Provisional application No. 60/687,586, filed on Jun. 3, 2005.
(60) Provisional application No. 60/690,859, filed on Jun. 15, 2005.

(51) Int. Cl. H04B 7/00

(52) U.S. Cl. 455/41.2

(57) ABSTRACT

A Bluetooth enabled device can include a transceiver that broadcasts and receives radio signals during a communication session and a processor with programmed instructions to modify a device name during connection setup for the communication session and to return the device name to a non-modified name at a time after connection setup has been completed or after the communication session ends. Another Bluetooth device can include a transceiver that broadcasts and receives radio signals during a communication session and a processor with programmed instructions to search for at least one device with a certain modified device name to initiate the communication session.

### CROSS REFERENCE TO RELATED PATENT APPLICATIONS

The present application claims priority to U.S. Provisional Patent Application Nos. 60/687,586 and 60/690,859, filed Jun. 3, 2005 and Jun. 15, 2005, respectively, each incorporated herein by reference.

### BACKGROUND OF THE INVENTION

1. Field of the Invention

The present invention relates generally to Bluetooth communication technologies. More specifically, the present invention relates to Bluetooth activation and peer discovery techniques and systems.

2. Background Information

This section is intended to provide a background or context. The description herein may include concepts that could be pursued, but are not necessarily ones that have been previously conceived or pursued. Therefore, unless otherwise indicated herein, what is described in this section is not prior art to the claims in this application and is not admitted to be prior art by inclusion in this section.

Bluetooth commonly refers to a specification for short-range radio links between mobile computers, mobile phones, digital cameras, and other portable devices. The Bluetooth specification is intended to provide less expensive radio protocol technology for communicating over shorter ranges. Bluetooth operates in the 2.4 GHz ISM radio frequency band. The Bluetooth specification is available on the Internet at http://www.bluetooth.org/spec.

In general, to make a Bluetooth connection, a device user has to activate a Bluetooth mode on a device first and give the device a device name. In order to find other Bluetooth devices, the device user has to start a Bluetooth “inquiry scan.” In this mode, the device scans for other Bluetooth devices and lists the device user's device name in a selection list from which Bluetooth-enabled devices can be selected.

Conventionally, Bluetooth connections are done manually by checking that Bluetooth is available on at least one other device and determining what the name of other devices are when browsing for Bluetooth devices. It may, however, be desirable not to see all the Bluetooth names in the list, but only those devices with whom the device user has agreed to connect, or devices which run the same application as the user. The latter example may be a game application that connects to other users that run the same game application. Another drawback to conventional Bluetooth connections is that often device names can easily be discerned, allowing Bluetooth “hacks”—individuals or even automated applications—to invade a Bluetooth-enabled device without authorization using the Bluetooth communications.

Thus, there is a need for a Bluetooth activation and discovery mechanism with a selective feature to enable selective Bluetooth communications and to facilitate security with Bluetooth communications. Further, there is a need to facilitate the activation of Bluetooth devices operating a common application, such as a game.

### SUMMARY OF THE INVENTION

In general, the present invention relates to facilitating the Bluetooth set up procedure by introducing a Bluetooth key and a discovery method bound to the key. The exemplary embodiments described herein provide this key and method, thereby enabling a security mechanism against Bluetooth hacks by permitting Bluetooth to be turned off by default and used only when needed. The exemplary embodiments can be used when hosting a Bluetooth game. In such an implementation, the host user of the game can press an assigned Bluetooth activation key and other devices having the same Bluetooth game can find the host device (with a modified device name) easily.

One exemplary embodiment relates to a device enabled for short-range radio communications. The device can include a transceiver that broadcasts and receives radio signals during a communication session and a processor with programmed instructions to modify a device name during connection setup for the communication session and to return the device name to a non-modified name at some time after the connection setup has been completed or after the communication session ends.

Another exemplary embodiment relates to a device enabled for short-range radio communications and searches for other devices with certain modified device names. The device includes a transceiver that broadcasts and receives radio signals during a communication session and a processor with programmed instructions to search for at least one device with a certain modified device name to initiate the communication session.

Another exemplary embodiment relates to a method for activating a communication session for short-range communications between at least two devices. The method includes activating a short-range radio mode on a first device having a device name, changing the device name for the first device in response to the activation of the short-range radio mode, establishing a communication connection with a second device using the changed device name, and returning the changed device name to the device name at some time after the short range radio mode has been completed or once the communication connection with the second device ends.

Another exemplary embodiment relates to a system in which short-range communications are made between at least two devices. The system includes a first device and a second device. The first device modifies a device name associated with the first device during a connection setup for a communication session. Further, the first device returns the modified device name to the device name at a time after the connection setup has been completed or after the communication session ends. The second device searches for the modified device name to engage in the communication session.

Another exemplary embodiment relates to a computer program product that activates a communication session for short-range communications between at least two devices. The computer program product includes computer code to activate a short-range radio mode on a first device having a device name, change the device name for the first device in response to the activation of the short-range radio mode, establish a communication connection with a second device using the changed device name, and return the changed device name to the device name at some time after the short-range radio mode has been completed or once the communication connection with the second device ends.

### BRIEF DESCRIPTION OF DRAWINGS

FIG. 1 is a diagram of one possible embodiment of an advanced communication network.

FIG. 2 is a block diagram of a mobile device.

FIG. 3 is a block diagram of a Bluetooth transceiver for use with a mobile device according to an exemplary embodiment.

FIG. 4 is a diagram illustrating operations performed in a method of Bluetooth activation and peer discovery in accordance with an exemplary embodiment.

FIG. 5 is a diagram illustrating a Bluetooth activation system in accordance with an exemplary embodiment.

### DETAILED DESCRIPTION OF EXEMPLARY EMBODIMENTS

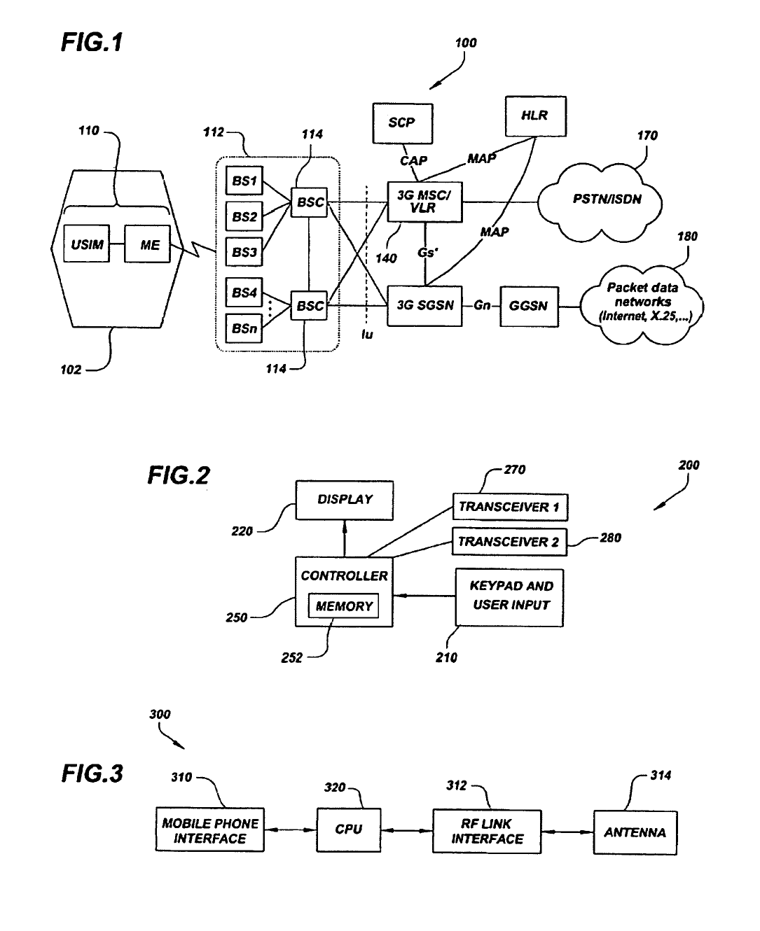

FIG. 1 shows schematically a telecommunications network 100. The network 100 includes a number of base stations (BSs) 112. Each base station 112 has a radio transceiver (not shown) capable of transmitting radio signals to and receiving radio signals from the area of an associated cell 102. By means of these signals, the base station can communicate with the mobile station 110 which may be a mobile station in the associated cell 102. The mobile station 110 includes at least a radio transceiver for cellular networks. Each base station is connected via a base station controller (BSC) 114 to a mobile switching center (MSC) 140. The MSC 140 is linked to the PSTN 170 or to other mobile switching centers (not shown). By means of this system, a user of the mobile station 110 can establish a telephone call or corresponding connection to a destination which can be, for example, a subscriber in the PSTN 170 or another mobile station in the network 100, or even a terminal in a computer network (not shown). The connection from the MSC 140 to packet data networks, like network 180, can be accomplished through the PSTN 170 or directly from the MSC 140.

FIG. 2 illustrates a block diagram of a mobile device 200. The mobile device 200 includes a keypad 210 for entering phone numbers or other input, for controlling menu operation and for entering device control functions. The mobile device 200 also includes a display 220. The display 220 may be used to show keypad entries, such as a number to be dialed, number lookup commands, device setup commands, etc. In addition, the display 220 may be used to display a representation of a game. For example, the mobile device 200 may include games programmed therein that the user may play while not using the other functions of the device. A controller 250 is a processor that processes the user inputs and controls the display 220.

The mobile device 200 also includes a transceiver 270 coupled to the controller 250 for transmitting and receiving radio signals. The preferred situation is that the mobile device 200 has a first transceiver 270 for cellular network connections and a second transceiver 280 for low power RF or local connections. The communication system provides a mechanism by which a user of the mobile device 200 receives information of games and/or game software (or other data or application information) broadcast from a remote transceiver (not shown) which without limitation has a short (limited) range. These remote transceivers, either simultaneously or on demand, broadcast information to one or more mobile devices 200. Mobile devices located within the broadcast will receive information, if desired.

The remote transceivers (not shown) broadcast information to the mobile device 200 by means of the low power RF link. The mobile device 200 receives the broadcast information using the transceiver 280 and stores the broadcast information in the memory 252 of the controller 250. The transceiver 270 may be a CDMA transceiver, a GSM transceiver, or a TDMA transceiver. The transceiver 280 is preferably a low power RF transceiver, such as a Bluetooth transceiver module, etc. The transceivers 270, 280 may have dual technology capabilities. Preferably, a Bluetooth transceiver operates as the low power RF transceiver in an unregulated spectrum such as 2.4 GHz.

FIG. 3 illustrates a block diagram of a Bluetooth module 300 for use with a device such as the mobile device illustrated in FIG. 2. The Bluetooth module 300 includes an interface to a mobile phone 310 and an interface to the RF link 312. An antenna 314 is provided for transmitting and receiving low power RF signals. A CPU 320 is provided for processing signals between the mobile phone interface 310 and the RF link interface 312.

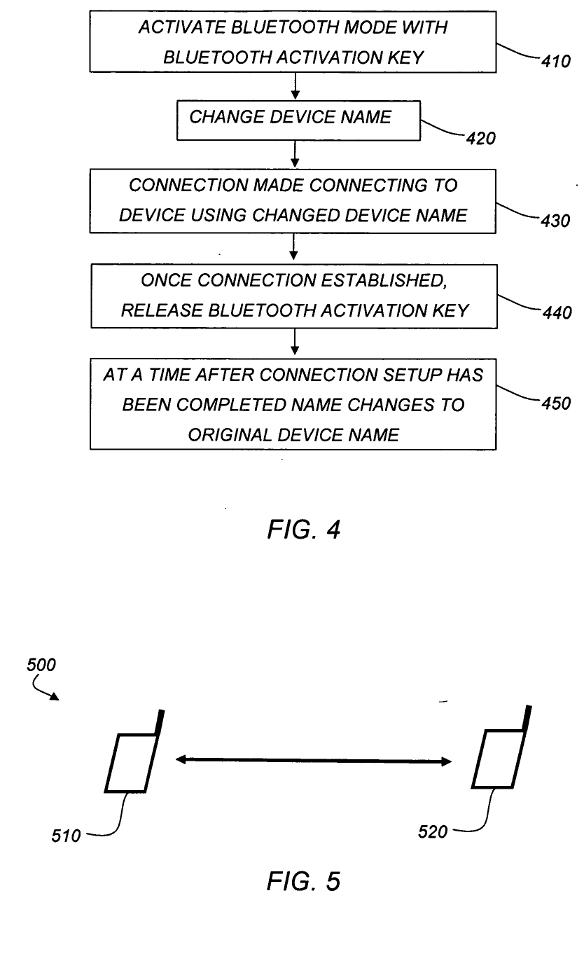

FIG. 4 illustrates operations performed in a method of Bluetooth activation and peer discovery. Additional, fewer, or different operations may be performed depending on the embodiment or implementation. In an operation 410, a Bluetooth mode is activated on a mobile device. The Bluetooth mode can be activated manually or in response to an application running on the mobile device. As an example of manual activation, the mobile device user can press a button that activates the Bluetooth mode. On a mobile phone, for example, the “#” key can activate Bluetooth mode. In an operation 420, the device name of the mobile device is temporarily changed to a pre-determined name, such as “NOKIA_BT_DEVICE,” or a modified pre-determined name, such as “XYZ_Peter's Nokia6650.”

In an operation 430, a connection is made to the mobile device with another device using the newly changed name. This connection may be to transfer files between devices, jointly play a game, or perform some other operation with multiple devices. In an operation 440, the connection is established and the Bluetooth activation key is released. Communication can continue for any period of time, short or long. In an operation 450, at a time after the connection setup has been completed or after the Bluetooth connection between the devices ends, the device name is changed to the original name before the device name change in operation 420. In the situation where the system crashes, the device name is restored during the boot-up procedure.

FIG. 5 illustrates a Bluetooth activation system 500. In the system, a mobile device 510 has set as a default that Bluetooth is turned off. When a user presses and holds a Bluetooth key on the mobile device 510, the Bluetooth communication mode turns on and the device name in Bluetooth properties changes to NOKIA_BT_DEVICE or some other pre-determined name. In an exemplary embodiment where the mobile device 510 is a mobile phone, the Bluetooth activation key can be the “#” key. Devices that want to connect to the mobile device 510 using Bluetooth search for this name by default in the Bluetooth coverage and, if found, connect to the mobile device 510. When a connection is established between the devices, the Bluetooth activation key can be released. The name of the mobile device 510 stays as a NOKIA_BT_DEVICE as long as the Bluetooth connection is maintained. When the connection ends, the device name changes to what is was previously. Alternatively, the name of the mobile device 510 changes back to what it was previously at a time after the connection setup is completed. This is possible because during the connection the Bluetooth devices identify each other by the Bluetooth address and not the Bluetooth device name.

It is unlikely that in normal situations there are two devices with the NOKIA_BT_DEVICE name inside the Bluetooth coverage. In the event that two devices in the same area have the same device name, a PIN (personal identification number) code query can be used to determine out the correct device.

The following is an example use case for simple image transfer between two devices. First, User A opens an Image Gallery in a mobile device 510 and browses for images. User B presses and holds down the # key (the assigned Bluetooth key) on a mobile device 520. As described above, pressing the Bluetooth activation key triggers the mobile device 520 to change (at least temporarily) its Bluetooth device name. User A selects the image and clicks an option to send the image via Bluetooth. User A's device searches and finds a Bluetooth device named NOKIA_BT_DEVICE (mobile device 520). A connection is established automatically because only one matching device was found. Once this connection is established, an image transfer is started from the mobile device 510 to the mobile device 520. User B is notified of the image transfer and he can release the Bluetooth activation key (e.g., the “#” key) on the mobile device 520.

According to an exemplary embodiment, the Bluetooth activation method described can be used for games played in a multi-player fashion involving a plurality of Bluetooth-enabled devices. As such, the multi-player games display only those devices which are running the same game at the same time, thus making selection of co-players easier. In this activation procedure, not all Bluetooth devices in the environment are listed during the connection setup procedure (only those that run the same game).

According to another exemplary embodiment, an application on a Bluetooth enabled device can modify the user-defined Bluetooth device name in such a way that an application-specific prefix or suffix can be added to the user-defined Bluetooth device name. For example, the user defined Bluetooth device name “Peter's 6650” can be changed to “XYZ_Peter's6650”. The modification can be performed when the application is started or when the application starts searching for other Bluetooth devices or at any time in between these activities. Another Bluetooth device running the same application looks for Bluetooth devices and makes a list of devices it has discovered. The list of devices can be analyzed, and only those devices having the application-specific prefix or suffix are shown to the user. The application-specific prefix can be removed and the user-defined Bluetooth name can be displayed to the user. In this way, the user may not be aware of the modified Bluetooth name. In the example, only “Peter's 6650” is shown. The application-specific prefix or suffix is preferably a random concatenation of characters that would not be part of a user-defined Bluetooth device name. The application-specific prefix or suffix however is usually unique to the application.

In one embodiment, the application is a Bluetooth multiplayer game. By using the described method, only those Bluetooth devices that are running the same game at the same time are shown in the list of Bluetooth devices.

When the modification of the user-defined Bluetooth device name is bound to a certain application (as described above) there is no need to have a special Bluetooth activation key (like the #-key) to use the invention, as the modification can be already controlled by the application.

The modification of the user-defined Bluetooth device name can be undone either at the end of the Bluetooth connection setup or when the application is closed. In a running Bluetooth connection, the devices are usually not identified by the user-defined name but by the unique Bluetooth device address (as defined in the Bluetooth standard). Therefore, the modified user-defined Bluetooth name can be changed back as soon as the Bluetooth connection is established.

The period during which the user-defined Bluetooth name is modified is preferably as short as possible. In this way, the probability that another application that uses Bluetooth on the same device is disturbed by the modification is reduced. Likewise, the probability that the user notices the modification is also reduced.

As a security mechanism, the user-defined Bluetooth name can be checked during the boot procedure of the Bluetooth device. Therefore, a second copy of the user-defined Bluetooth name can be stored in a safe location of the device. Modification of the device name in the safe location can be limited to the user, precluding modification by the application (or any other application running on the device). The reason for this security mechanism is that the application may crash during the Bluetooth connection setup and may not be able to change the modified user-defined Bluetooth name back. By using the security mechanism, the modified user-defined Bluetooth name can be changed back at the next boot procedure of the device or when the user wants to change the user-defined Bluetooth name.

While several embodiments of the invention have been described, it is to be understood that modifications and changes will occur to those skilled in the art to which the invention pertains. Accordingly, the claims appended to this specification are intended to define the invention precisely.

1. A device enabled for short-range radio communications, the device comprising:
a transceiver that broadcasts and receives radio signals during a communication session; and
a processor with programmed instructions to modify a device name during connection setup for the communication session and to return the device name to a non-modified name at a time after the connection setup has been completed.

2. The device of claim 1, further comprising an activation key that triggers the connection setup for the communication session.

3. The device of claim 2, wherein the activation key is a “#” key.

4. The device of claim 1, wherein the radio signals are Bluetooth signals.

5. The device of claim 1, further comprising a second transceiver that communicates telephone communications.

6. The device of claim 5, wherein the second transceiver is a GSM transceiver.

7. The device of claim 1, wherein the connection setup is triggered by an application.

8. The device of claim 7, wherein the application is a multi-player game.

9. The device of claim 1, wherein the device name is modified to a pre-determined name.

10. The device of claim 9, wherein the pre-determined name is associated with a particular application.

11. A device enabled for short-range radio communications and searches for other devices with certain modified device names, the device comprising:
a transceiver that broadcasts and receives radio signals during a communication session; and
a processor with programmed instructions to search for at least one device with a certain modified device name to initiate the communication session.

12. The device of claim 11, wherein the communication session is initiated by an activation key.

13. The device of claim 12, wherein the activation key is a “#” key.

14. The device of claim 11, wherein the communication session is initiated by a certain application.

15. The device of claim 14, wherein the certain application is a multi-player game.

16. The device of claim 14, wherein the certain modified device name is a pre-determined name associated with the multi-player game.

17. A method for activating a communication session for short-range communications between at least two devices, the method comprising:
activating a short-range radio mode on a first device having a device name;
changing the device name for the first device in response to the activation of the short-range radio mode;
establishing a communication connection with a second device using the changed device name; and
returning the changed device name to the device name at a time after connection setup with the second device has been completed.

18. A method of claim 17, wherein the short-range radio mode is a Bluetooth mode.

19. The method of claim 17, wherein activating the short-range radio mode on the first device having a device name comprises receiving a signal from an activation key on the first device.

20. The method of claim 17, further comprising communicating game information to the first device and the second device, wherein the game information is associated with a multi-player game.

21. A system in which short-range communications are made between at least two devices, the system comprising:
a first device that modifies a device name associated with the first device during a connection setup for a communication session, wherein the first device returns the modified device name to the device name at a time after connection setup has been completed or after the communication session ends, wherein the communication session is a short-range radio communication session; and
a second device that searches for the modified device name to engage in the communication session.

22. The system of claim 21, wherein the first device includes an activation key to engage the communication session.

23. The system of claim 21, wherein the short-range radio communication session is a Bluetooth communication session.

24. The system of claim 21, wherein the first device includes an application which engages the communication session.

25. The system of claim 24, wherein the application is a multi-player game.

26. The system of claim 21, wherein the first device and the second device include a common game application.

27. A computer program product that activates a communication session for short-range communications between at least two devices, the computer program product comprising:
computer code to activate a short-range radio mode on a first device having a device name;
computer code to change the device name for the first device in response to the activation of the short-range radio mode;
computer code to establish a communication connection with a second device using the changed device name; and
computer code to return the changed device name to the device name at a time after connection setup with the second device has been completed.
